(19) United States
(12) Patent Application Publication
(10) Pub. No.: US 2017/0351565 A1
(43) Pub. Date: Dec. 7, 2017

(54) APPARATUS AND METHOD TO PROVIDE A MOUNTED ELECTRONIC PART WITH INFORMATION RELATED TO A FAILURE OCCURRENCE THEREIN

(71) Applicant: FUJITSU LIMITED, Kawasaki-shi (JP)

(72) Inventor: Yasuhiro Matsumura, Kawasaki (JP)

(73) Assignee: FUJITSU LIMITED, Kawasaki-shi (JP)

(21) Appl. No.: 15/584,629

(22) Filed: May 2, 2017

(30) Foreign Application Priority Data
Jun. 7, 2016 (JP) 2016-113718

(51) Int. Cl. G06F 11/07; G06F 11/22; G06F 13/40; G06F 11/34; G06F 11/30; H04L 12/24

(52) U.S. Cl. CPC G06F 11/0766; G06F 11/0748; G06F 13/4022; G06F 11/3409; G06F 11/0724; G06F 11/2294; G06F 11/079; H04L 41/00; G06F 11/30

(57) ABSTRACT

An apparatus includes a plurality of mounting slots each configured to mount an electronic part including a first memory. The apparatus collects, through a first path, from the electronic part mounted on each of the plurality of mounting slots, event information indicating an operating state of the electronic part, and stores the collected event information in a second memory included in the apparatus. When the event information stored in the second memory has a first level of importance, the apparatus causes the event information stored in the second memory to be stored, through a second route, in the first memory of the electronic part from which the event information having the first level of importance has been collected.

### CROSS-REFERENCE TO RELATED APPLICATION

This application is based upon and claims the benefit of priority of the prior Japanese Patent Application No. 2016-113718, filed on Jun. 7, 2016, the entire contents of which are incorporated herein by reference.

### FIELD

The embodiments discussed herein are related to apparatus and method to provide a mounted electronic part with information related to a failure occurrence therein.

### BACKGROUND

In an electronic apparatus, such as a computer system including multiple replaceable electronic parts, when the electronic apparatus does not normally operate due to the occurrence of a failure or the like in the electronic parts, the electronic part causing the problem is replaced. For example, when the electronic part recommended to be replaced is detected based on failure information collected from the electronic parts, an error log including environmental information of the electronic apparatus is stored in a non-volatile memory mounted on the electronic part recommended to be replaced. This enables recovery based on the information related to the failure (see, for example, International Publication Pamphlet No. WO 2007/088606). Moreover, when there is a failure in an electronic part, the cause of the problem is readily determined by recording failure information in a recording unit in each electronic part, together with status information on those other than the electronic part with the failure (see for example, Japanese Laid-open Patent Publication No. 2006-227665).

### SUMMARY

According to an aspect of the invention, an apparatus includes a plurality of mounting slots each configured to mount an electronic part including a first memory. The apparatus collects, through a first path, from the electronic part mounted on each of the plurality of mounting slots, and stores the collected event information in a second memory included in the apparatus, where event information indicates an operating state of the electronic part. When the event information stored in the second memory has a first level of importance, the apparatus causes the event information stored in the second memory to be stored, through a second route, in the first memory of the electronic part from which the event information having the first level of importance has been collected.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a configuration of an information processing apparatus, according to an embodiment;

FIG. 2 is a diagram illustrating an example of operations of an information processing apparatus, according to an embodiment;

FIG. 3 is a diagram illustrating an example of a configuration of an information processing apparatus, according to an embodiment;

FIG. 4 is a diagram illustrating an example of a configuration of a baseboard management controller (BMC), according to an embodiment;

FIG. 5 is a diagram illustrating an example of information stored in a log database, according to an embodiment;

FIG. 6 is a diagram illustrating an example of operations of an information processing apparatus, according to an embodiment;

FIG. 7 is a diagram illustrating an example of an operational flowchart for a process when a BMC detects coupling of an electronic part to an output port, according to an embodiment;

FIG. 8 is a diagram illustrating an example of an operational flowchart for storing event information in a log database, according to an embodiment;

FIG. 9 is a diagram illustrating an example of an operational flowchart for storing failure information and abnormal information selected from a log database in a log list, according to an embodiment;

FIG. 10 is a diagram illustrating an example of processing of extracting failure information and abnormal information from a log database, according to an embodiment; and

FIG. 11 is a diagram illustrating an example of an operational flowchart for outputting failure information and abnormal information stored in a log list to a mounted part that has generated failure information, according to an embodiment.

### DESCRIPTION OF EMBODIMENTS

In the electronic part, when there is a failure in a control circuit such as a data write circuit coupled on a route used in a normal operation, access to the electronic part through the route used in the normal operation is blocked. In this case, there is a risk that failure information is not stored in the electronic part even when processing of storing the failure information in the electronic part with the failure is executed through the route used in the normal operation. When the failure information is not stored in the electronic part, it is difficult to determine the cause of the problem.

It is desirable to store event information of a second level generated by an electronic part, together with event information of a second level generated by another electronic part, in the electronic part with a failure without being affected by the influence of the failure.

Hereinafter, embodiments are described with reference to the drawings.

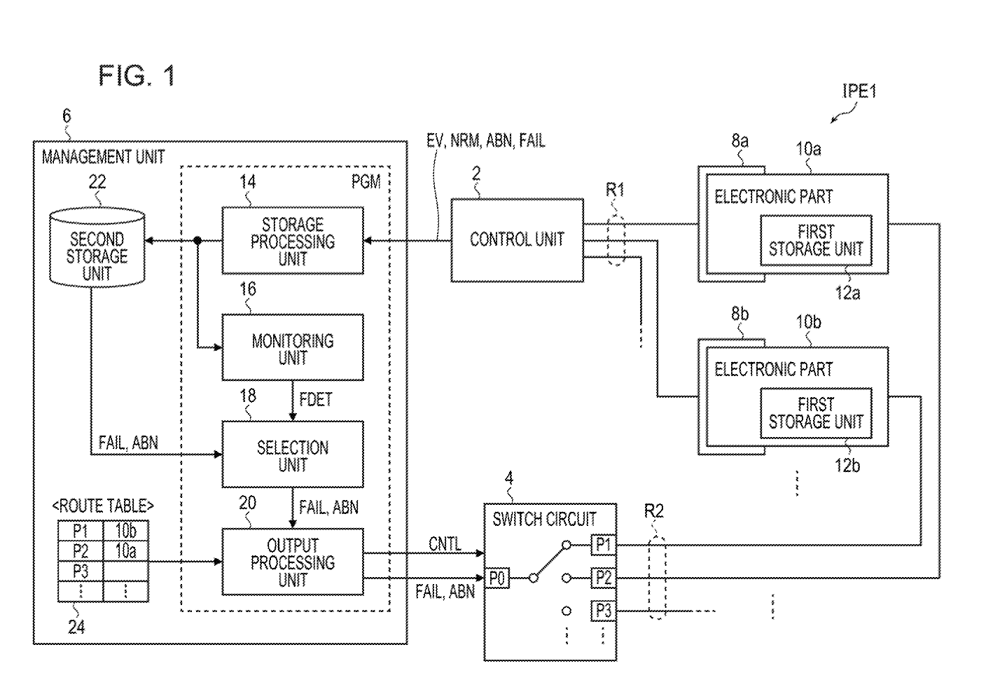

FIG. 1 illustrates an embodiment of an information processing apparatus, a method for controlling the information processing apparatus, and a program for controlling the information processing apparatus. An information processing apparatus IPE1 illustrated in FIG. 1 includes a control unit 2, a switch unit 4, a management unit 6, and multiple mounting slots 8 (8a and 8b) on which electronic parts 10 (10a and 10b) respectively including first storage units 12 (12a and 12b) are capable of being mounted. For example, the electronic parts 10 are each a peripheral component interconnect (PCI) standard card or the like. The mounting slots 8 are each a connector or the like for detachably mounting the card. The first storage units 12 are each a non-volatile memory such as a hard disk drive (HDD) or a flash memory. The control unit 2, the switch unit 4, the management unit 6, and the mounting slots 8 are mounted on a printed circuit board or the like.

The control unit 2 is electrically coupled to the mounting slots 8 through a route R1 formed using signal wiring or the like on the printed circuit board. The control unit 2 controls operations of the electronic parts 10 mounted on the mounting slots 8 and collects event information EV indicating operating states (events) of the electronic parts 10 through the route R1. The event information EV includes parts information for identifying the electronic parts 10 that have issued the event information EV. The control unit 2 transfers the collected event information EV to the management unit 6. For example, the control unit 2 is a processor such as a central processing unit (CPU) that controls operations of the information processing apparatus IPE1.

In the following description, the electronic parts 10 mounted on the mounting slots 8 are also referred to as the mounted parts 10 (10a and 10b). For example, the event information EV includes any of normal information NRM indicating occurrence of a normal event, abnormal information ABN outputted by the mounted part 10 when detecting a temporary error or the like, and failure information FAIL outputted by the mounted part 10 when detecting a failure. Note that the abnormal information ABN indicates an abnormal operating state of the mounted part 10, which occurs temporarily, and does not indicate a failure. The failure information FAIL is an example of event information EV of a first level of importance, while the abnormal information ABN is an example of event information EV of a second level of importance, which is lower than the first level.

The switch circuit 4 includes a port P0 coupled to the management unit 6 and multiple ports P1, P2, and P3 electrically coupled to the mounted parts 10a and 10b or the like through a route R2 via signal cables or the like. The switch unit 4 couples the port P0 to any one of the ports P1 to P3, based on a control signal CNTL outputted from the management unit 6. The ports P1 to P3 are each an example of a first port, while the port P0 is an example of a second port. The control signal CNTL is an example of control information for coupling the port (any of P1 to P3) coupled to the mounted part 10 that has outputted the failure information FAIL, to the port P0.

The management unit 6 includes a storage processing unit 14, a monitoring unit 16, a selection unit 18, an output processing unit 20, a second storage unit 22, and a route table 24. For example, the management unit 6 is a baseboard management controller (BMC) that manages operations of the control unit 2 and the like mounted on the printed circuit board in the information processing apparatus IPE1.

In the example illustrated in FIG. 1, the storage processing unit 14, the monitoring unit 16, the selection unit 18, and the output processing unit 20 are realized by a program PGM executed by the BMC. However, the storage processing unit 14, the monitoring unit 16, the selection unit 18, and the output processing unit 20 may be realized by hardware mounted on the BMC.

The storage processing unit 14 stores the event information EV (normal information NRM, abnormal information ABN, or failure information FAIL) sequentially transferred from the control unit 2, in the second storage unit 22. The second storage unit 22 is a storage device, such as a hard disk drive (HDD) or a solid state drive (SSD). Note that the second storage unit 22 may be disposed outside the management unit 6. The route table 24 is allocated to a semiconductor memory, such as a flash memory or a static random access memory (SRAM), mounted in the management unit 6, and holds information that identifies the mounted parts 10 respectively coupled to the ports P1 to P3, in the switch circuit 4. More specifically, the route table 24 holds coupling information indicating coupling relationships between the multiple ports P1 to P3 and the mounted parts 10. In other words, the route table 24 stores the information that identifies the mounted parts 10 in association with the ports (any of P1 to P3) to which the mounted parts 10 are coupled.

The monitoring unit 16 monitors the event information EV that is stored in the second storage unit 22 by the storage processing unit 14. When the event information EV is the failure information FAIL, the monitoring unit 16 outputs detection information FDET indicating the detection of the failure information FAIL to the selection unit 18. Note that the mounted parts 10 do not necessarily output the failure information FAIL only in case of failure of internal circuits or the like. For example, the mounted parts 10 output the failure information FAIL to the route R1 also when communication with unillustrated other electronic parts coupled to the mounted parts 10 is blocked by failure of the other electronic parts.

The selection unit 18 selects the failure information FAIL detected by the monitoring unit 16 and the abnormal information ABN indicating the abnormal operating condition, from among the event information EV stored in the second storage unit 22, based on the detection information FDET outputted from the monitoring unit 16. Then, the selection unit 18 outputs the selected failure information FAIL and the abnormal information ABN to the output processing unit 20.

The output processing unit 20 detects a port (any of P1 to P3) to which the mounted part 10 that has outputted the failure information FAIL is coupled, by referring to the route table 24, based on the parts information indicating the mounted parts 10 included in the failure information FAIL received from the selection unit 18. Then, the output processing unit 20 outputs a control signal CNTL for coupling the port P0 to the port (any of P1 to P3) coupled to the mounted part 10 that has outputted the failure information FAIL, to the switch circuit 4, based on the detection result. The coupling inside the switch circuit 4 is switched based on the control signal CNTL.

After the coupling inside the switch unit 4 is switched, the output processing unit 20 outputs the failure information FAIL and abnormal information ABN received from the selection unit 18 to the mounted part 10 that has outputted the failure information FAIL, through the switch circuit 4 and the route R2. Then, the output processing unit 20 causes the mounted part 10 to store the failure information FAIL and the abnormal information ABN in the first storage unit 12.

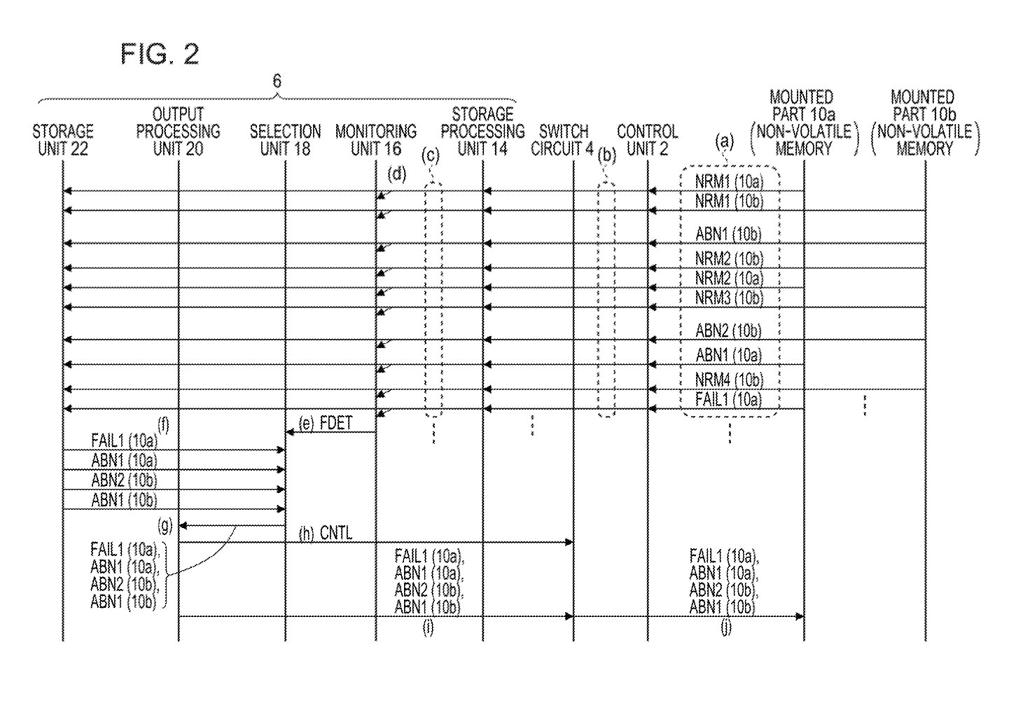

The output processing unit 20 outputs failure information FAIL and abnormal information ABN to the electronic part 10, which are important information in a failure analysis to be executed by a manufacturer of the mounted parts 10 to be described with reference to FIG. 2, among the event information EV stored in the second storage unit 22. By storing only the important event information EV in the first storage unit 12, the first storage unit 12 with a minimum storage capacity may be mounted in the electronic part 10 or only a minimum storage area may be required to be used in the first storage unit 12 mounted in the electronic part 10. Therefore, cost increase associated with mounting the first storage units 12 in the electronic parts 10 may be minimized.

Note that the management unit 6 may be coupled to the electronic parts 10a and 10b through the route R2, without through the switch circuit 4. In this case, the information processing apparatus IPE1 includes no switch circuit 4, and the output processing unit 20 is coupled directly to the route R2. The route table 24 holds information indicating correspondence between the route R2 and the mounted parts 10, instead of information indicating correspondence between the ports P1 to P3 and the mounted parts 10. The output processing unit 20 detects the route R2 to which the mounted part 10 that has outputted the failure information FAIL is coupled, by referring to the route table 24, based on the parts information indicating the mounted parts 10 included in the failure information FAIL received from the selection unit 18. Then, the output processing unit 20 outputs the failure information FAIL and the abnormal information ABN to the electronic part 10 through the detected route R2.

In case of failure of the mounted part 10, access to the first storage unit 12 through the route R1 used in a normal operation is sometimes blocked. By transferring the failure information FAIL and the abnormal information ABN to the mounted part 10 through the route R2, which is different from the route R1, the probability that the failure information FAIL and the abnormal information ABN will be stored in the first storage unit 12 may be increased compared with the case of using the route R1. Thus, the possibility that the cause of failure will be specified in the failure analysis to be executed by the manufacturer of the mounted parts 10 to be described with reference to FIG. 2 may be increased.

Note that the output processing unit 20 may write the failure information FAIL and the abnormal information ABN directly into the first storage unit 12 in the mounted part 10. Moreover, when the mounted part 10 that has generated the failure information FAIL has a function to store the failure information FAIL in the first storage unit 12, the output processing unit 20 may output only the abnormal information ABN to the switch unit 4 without the selection unit 18 selecting the failure information FAIL from the second storage unit 22.

FIG. 2 illustrates an example of operations of the information processing apparatus IPE1 illustrated in FIG. 1. More specifically, FIG. 2 illustrates an example of a method for controlling the information processing apparatus IPE1, and operations of the management unit 6 illustrated in FIG. 2 may be realized by executing a program for controlling the information processing apparatus IPE1.

Each of the mounted parts 10a and 10b outputs event information EV (normal information NRM, abnormal information ABN, or failure information FAIL) to the control unit 2 every time an event occurs ((a) in FIG. 2). The normal information NRM is event information EV indicating a normal operating state of the mounted parts 10 without failure or abnormal. In FIG. 2, to simplify the description, serial numbers for each of the mounted parts 10a and 10b are added to the ends of the normal information NRM, the abnormal information ABN, and the failure information FAIL.

The control unit 2 transfers the received event information EV to the storage processing unit 14 ((b) in FIG. 2). The storage processing unit 14 stores the event information EV received from the control unit 2 in the second storage unit 22 ((c) in FIG. 2). The monitoring unit 16 monitors the event information EV outputted to the second storage unit 22 by the storage processing unit 14 ((d) in FIG. 2).

In the example illustrated in FIG. 2, upon detection of failure information FAIL1 (10a) outputted from the mounted part 10a ((e) in FIG. 2), the monitoring unit 16 outputs detection information FDET to the selection unit 18. The selection unit 18 searches the event information EV stored in the second storage unit 22, based on the detection information FDET outputted from the monitoring unit 16, to extract the failure information FAIL1 (10a) and abnormal information ABN1 (10a), ABN2 (10b), and ABN1 (10b) ((f) in FIG. 2). The selection unit 18 outputs the extracted failure information FAIL1 (10a) and abnormal information ABN1 (10a), ABN2 (10b), and ABN1 (10b) to the output processing unit 20 ((g) in FIG. 2).

The output processing unit 20 outputs a control signal CNTL to the switch unit 4, based on the failure information FAIL1 (10a) received from the selection unit 18 ((h) in FIG. 2), The control signal CNTL includes information for coupling the port P0 to the port P2 coupled to the mounted part 10a that has generated the failure information FAIL1 (10a). The switch unit 4 couples the port P0 to the port P2, based on the control signal CNTL.

Next, the output processing unit 20 outputs the failure information FAIL1 (10a) and abnormal information ABN1 (10a), ABN2 (10b), and ABN1 (10b) received from the selection unit 18 to the mounted part 10 that has outputted the failure information FAIL, through the switch unit 4 ((i) and (j) in FIG. 2). Then, the output processing unit 20 causes the mounted part 10 that has outputted the failure information FAIL to execute processing of storing the failure information FAIL1 (10a) and abnormal information ABN1 (10a), ABN2 (10b), and ABN1 (10b) in the first storage unit 12. Thus, the abnormal information ABN1 (10a), ABN2 (10b), and ABN1 (10b) on the mounted part 10a and the other mounted part 10b are stored, together with the failure information FAIL1 (10a), in the first storage unit 12 in the mounted part 10a that has outputted the failure information FAIL.

Thereafter, a user of the information processing apparatus IPE1 or the like replaces the mounted part 10a with a new electronic part 10, based on the failure information FAIL1 (10a) outputted to a display device and the like by the control unit 2. For example, the mounted part 10a removed from the information processing apparatus IPE1 is sent to the manufacturer of the mounted part 10a, and the manufacturer performs a failure analysis to analyze the cause of occurrence of the failure information FAIL1 (10a).

In this event, the first storage unit 12 of the mounted part 10a stores not only the failure information FAIL1 but also abnormal information ABN on the other mounted part 10b. More specifically, the first storage unit 12 stores information indicating the operating condition of the information processing apparatus IPE1 immediately before the occurrence of the failure information FAIL1. Therefore, an analyst or the like who analyzes the cause of failure may increase the possibility that the cause of failure may be specified, compared with the case of performing a failure analysis using only the failure information FAIL1 on the mounted part 10a. For example, when the cause of occurrence of the failure information FAIL1 (10a) resides in the other mounted part 10b that has generated the abnormal information ABN, performing the failure analysis using the failure information FAIL1 and the abnormal information ABN may make it easier to specify the cause of failure.

Furthermore, since the abnormal information ABN on the other mounted part 10b is stored in the first storage unit 12 of the mounted part 10a, the analyst or the like who analyzes the cause of failure may acquire the abnormal information ABN outputted by the other mounted part 10b without making an inquiry to the user of the information processing apparatus IPE1 or the like. Moreover, even when the abnormal information ABN on the other mounted part 10b is lost from the information processing apparatus IPE1 with time due to the prolonged failure analysis, the analyst or the like may acquire the abnormal information ABN outputted by the other mounted part 10b.

Note that the output processing unit 20 may output coupling information indicating relationships between the information for identifying the mounted parts 10 and the ports P1 to P3, which is held in the route table 24, to the mounted parts 10 when outputting the failure information FAIL and the abnormal information ABN to the mounted parts 10. In this case, the analyst or the like may grasp the coupling status of the mounted parts to the information processing apparatus IPE1 in the event of occurrence of failure information FAIL, without making an inquiry to the user of the information processing apparatus IPE1 or the like. As a result, the cause of failure may be more readily specified compared with the case where no coupling information is outputted to the mounted parts 10.

As described above, in the embodiment illustrated in FIGS. 1 and 2, the management unit 6 transfers the failure information FAIL and the abnormal information ABN to the route R2, which is different from the route R1 used in a normal operation. Therefore, the probability that the failure information FAIL and the abnormal information ABN will be stored in the first storage unit 12 in the event of occurrence of the failure information FAIL may be increased compared with the case of using the route R1. More specifically, the failure information FAIL and abnormal information ABN generated by the mounted part 10 may be stored, together with the abnormal information ABN generated by the other mounted part 10, in the electronic part 10 that has generated the failure information FAIL, without being affected by the influence of the failure. As a result, in the case of analyzing the cause of occurrence of the failure information FAIL at a location different from a location where the information processing apparatus IPE1 is installed, the possibility that the cause of failure will be specified may be increased by using the mounted part 10 that has generated the failure information FAIL, for example.

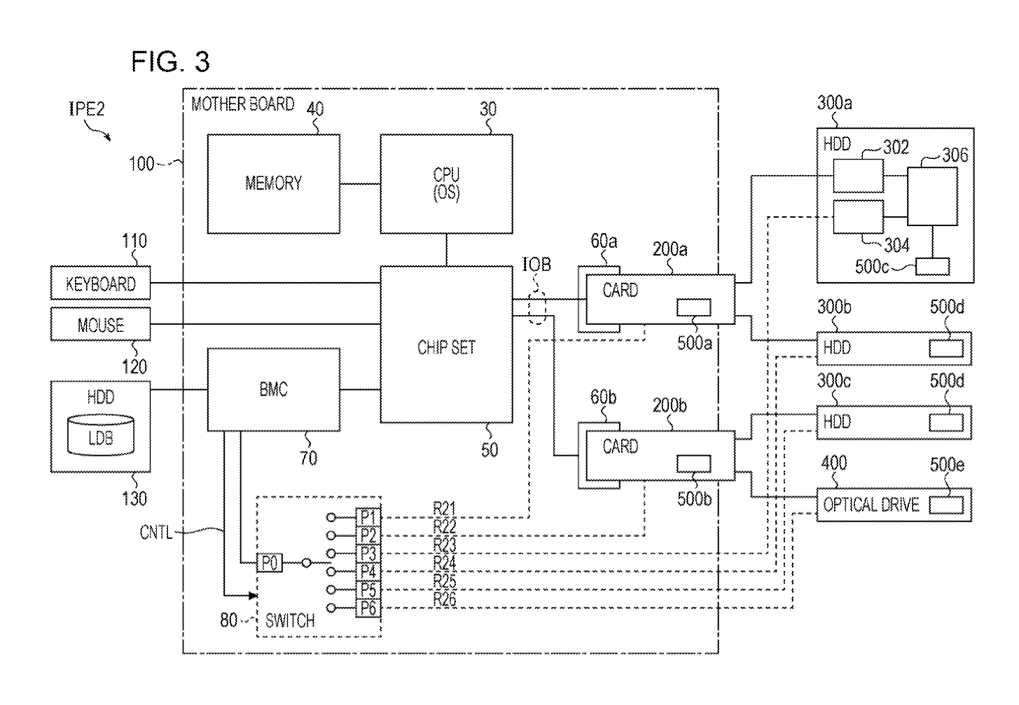

FIG. 3 illustrates another embodiment of an information processing apparatus, a method for controlling the information processing apparatus, and a program for controlling the information processing apparatus. The same or similar components as or to those described in the embodiment illustrated in FIGS. 1 and 2 are denoted by the same reference numerals, and detailed description thereof is omitted. An information processing apparatus IPE2 according to this embodiment includes a CPU 30, a memory 40, a chip set 50, card slots 60a and 60b, a BMC 70, and a switch 80, all of which are mounted on a mother board 100; a keyboard 110; a mouse 120; and an HDD 130. The CPU 30 is an example of a control unit, the BMC 70 is an example of a management unit, and the switch 80 is an example of a switch circuit, In the following description, the card slots 60a and 60b are also referred to as the card slots 60. Note that the number of the card slots 60 mounted on the mother board 100 may be three or more.

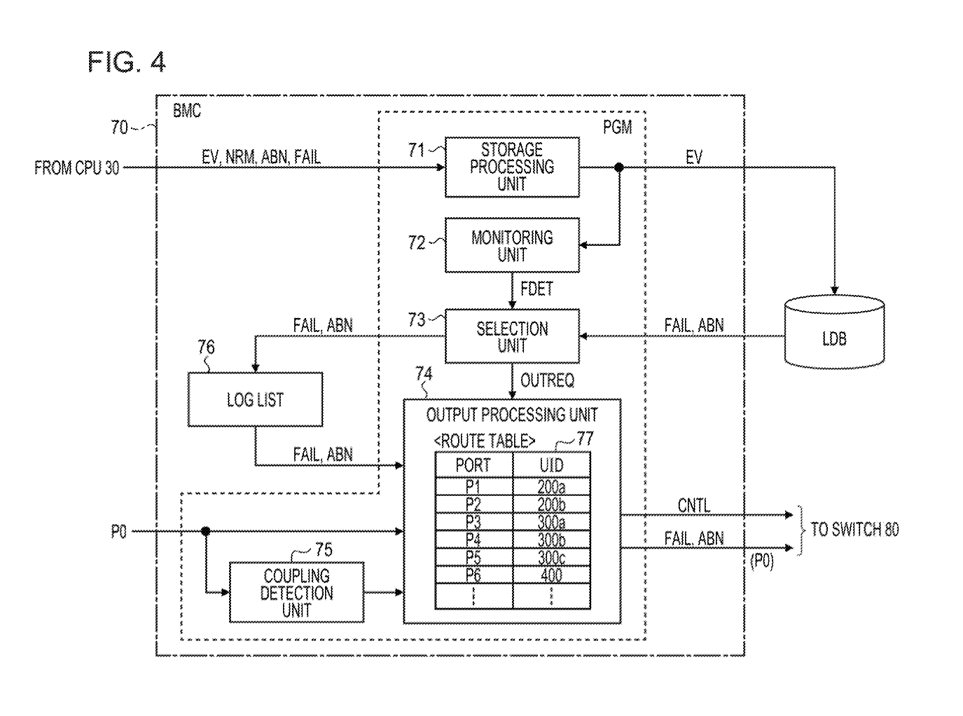

The CPU 30 realizes functions of the information processing apparatus IPE2 by executing a basic program such as an OS and application programs. The CPU 30 has a function to transfer event information EV (FIG. 4) supplied from a card 200 through an input-output bus IOB and the chip set 50, to the BMC 70 through the chip set 50. Note that the CPU 30 may store the received event information EV in the memory 40 or an unillustrated HDD or the like.

The memory 40 stores programs to be executed by the CPU 30, data to be used in the programs, and the like. For example, the memory 40 is a dual inline memory module (DIMM) equipped with multiple synchronous dynamic random access memories (SDRAMs).

The card slots 60a and 60b are coupled to the chip set 50 through the input-output bus IOB. The input-output bus IOB is a peripheral component interconnect (PCI) bus or a PCI express bus. Note that the input-output bus IOB may be a bus of another standard. Cards 200 (200a and 200b) such as PCI cards are detachably mounted in the card slots 60 (60a and 60b). The cards 200a and 200b are each an example of an electronic part. The card slots 60 are each an example of a mounting slot that mounts a card CARD. The input-output bus MB is an example of a first route.

In the example illustrated in FIG. 3, HDDs 300a and 300b are coupled to the card 200a, while an HDD 300c and an optical drive 400 are coupled to the card 200b. Event information EV to be generated by the cards 200 is outputted directly to the input-output bus MB through the card slots 60. Event information EV to be generated by the HDDs 300a to 300c and the optical drive 400 is outputted to the input-output bus IOB through the cards 200 and the card slots 60. The cards 200a and 200b, the HDDs 300a to 300c, and the optical drive 400 include non-volatile memories 500 (500a, 500b, 500c, 500d, 500e, and 500f) such as flash memories. Note that the number of the electronic parts coupled to each of the cards 200 is not limited to two. Moreover, the HDDs 300 and the like may be coupled in series to the cards 200. The non-volatile memories 500 are each an example of a first storage unit.

The cards 200a and 200b, the HDDs 300a to 300c, and the optical drive 400 are electrically coupled to the switch 80 through signal lines R2 (R21, R22, R23, R24, R25, and R26) such as signal cables. The signal lines R2 are an example of a second route. In the following description, the signal lines R2 are also referred to as routes R2 (R21, R22, R23, R24, R25, and R26). Moreover, in the following description, the cards 200 mounted in the card slots 60 are also referred to as mounted parts. Note that the mother board 100 may be fitted with sockets, connectors or the like, instead of the card slots 60. In this case, electronic parts other than the cards 200 are detachably mounted in the sockets, connectors or the like.

For example, the HDD 300a includes a transmission and reception, unit 302, a reception unit 304, and a selection unit 306. The transmission and reception unit 302 outputs information, such as data received through the input-output bus IOB, to the selection unit 306, and outputs information, such as data to be outputted from the selection unit 306, to the input-output bus IOB. The reception unit 304 outputs event information EV received through the signal line R23, to the selection unit 306. The selection unit 306 stores the information received from the transmission and reception unit 302 or the event information EV received from the reception unit 304, in the non-volatile memory 500c, and outputs information, such as data to be outputted from the non-volatile memory 500c, to the transmission and reception unit 302.

Note that, as in the case of the HDD 300a, the cards 200a and 200b, the HDDs 300b and 300c, and the optical drive 400 may each include a transmission and reception unit 302, a reception unit 304, and a selection unit 306. More specifically, the cards 200a and 200b, the HDDs 300b and 300c, and the optical drive 400 may each include: a transmission and reception unit 302 coupled to the input-output bus IOB; a reception unit 304 coupled to the signal line R2; and a selection unit 306 coupled to the non-volatile memory 500. Furthermore, as in the case of the HDD 300a, the electronic parts 10a and 10b illustrated in FIG. 1 may each include a transmission and reception unit 302, a reception unit 304, and a selection unit 306. More specifically, the electronic parts 10a and 10b illustrated in FIG. 1 may each include a transmission and reception unit 302 coupled to the route R1, a reception unit 304 coupled to the route R2, and a selection unit 306 coupled to the first storage units 12a and 12b.

The chip set 50 manages input and output of information, such as data that is transferred between the CPU 30 and any of the BMC 70, the electronic parts such as the cards 200 (200a and 200b) coupled to the card slots 60a and 60b, the keyboard 110, and the mouse 120.

The BMC 70 controls a power-supply voltage to be supplied to the CPU 30, a frequency of a clock to be supplied to the CPU 30, a rotation speed of an unillustrated fan, and the like. Also, the BMC 70 has a function to store event information EV transferred from the CPU 30 through the chip set 50 in a log database LDB allocated to the HDD 130. Note that the log database LDB may be provided in the BMC 70. The log database LDB is an example of a second storage unit that stores event information EV transferred from the CPU.

Furthermore, the BMC 70 has a function to communicate with the mounted parts (cards 200, HDDs 300, optical drive 400, and the like) coupled to ports P1, P2, P3, P4, P5, and P6 of the switch 80 through the routes R21 to R26. The BMC 70 and the mounted parts communicate with each other by using an inter-integrated circuit (I2C; registered trademark) method, a serial peripheral interface (SPI; registered trademark) method or the like. For example, the BMC 70 transmits predetermined event information EV extracted from the event information. EV held in the log database LDB to the mounted part through the switch 80 and any one of the routes R21 to R26. Upon receipt of the event information EV, the mounted part stores the event information in the non-volatile memory 500 included therein.

The switch 80 includes a port P0 coupled to the BMC 70 and the ports P1 to P6 respectively coupled to the routes R21 to R26. In the following description, for convenience, the port P0 is also referred to as the input port P, and the ports P1 to P6 are also referred to as the output ports P. The switch 80 couples the input port P0 to any one of the output ports P1 to P6 based on a control signal CNTL to be received from the BMC 70. Note that the number of the output ports P1 to P6 is not limited to six.

FIG. 4 illustrates an example of the BMC 70 illustrated in FIG. 3. The BMC 70 includes a storage processing unit 71, a monitoring unit 72, a selection unit 73, an output processing unit 74, a coupling detection unit 75, and a log list 76. In the example illustrated in FIG. 4, the storage processing unit 71, the monitoring unit 72, the selection unit 73, the output processing unit 74, and the coupling detection unit 75 are realized by a program PGM to be executed by the BMC 70. However, the storage processing unit 71, the monitoring unit 72, the selection unit 73, the output processing unit 74, and the coupling detection unit 75 may be realized by hardware mounted on the BMC 70. Note that the storage processing unit 71, the monitoring unit 72, the selection unit 73, the output processing unit 74, the coupling detection unit 75, and the log list 76 may be provided in a controller different from the BMC 70.

The storage processing unit 71 stores event information EV (normal information NPM, abnormal information ABN or failure information FAIL) sequentially transferred from the CPU 30, in the log database LDB, and notifies the monitoring unit 72 of the stored event information EV. Note that the event information EV is stored in the order of time of occurrence of the event information EV. The operations of the storage processing unit 71 are the same as those of the storage processing unit 14 illustrated in FIG. 1.

The monitoring unit 72 monitors the event information EV notified from the storage processing unit 71. When the event information EV is failure information FAIL, the monitoring unit 72 outputs detection information FDET indicating the detection of the failure information FAIL to the selection unit 73. The operations of the monitoring unit 72 are the same as those of the monitoring unit 16 illustrated in FIG. 1.

The selection unit 73 selects the failure information FAIL detected by the monitoring unit 72 and abnormal information ABN indicating an abnormal operating condition from among the event information EV stored in the log database LDB, based on the detection information FDET outputted from the monitoring unit 72. In this event, the selection unit 73 selects, from the log database LDB, abnormal information ABN that has occurred within a range (search range) from a reference time that is the time of occurrence of the failure information FAIL to a time that goes back a predetermined period of time. Note that the time of occurrence of the event information EV is included in the event information EV. Then, the selected failure information FAIL and abnormal information ABN are registered in the log list 76.

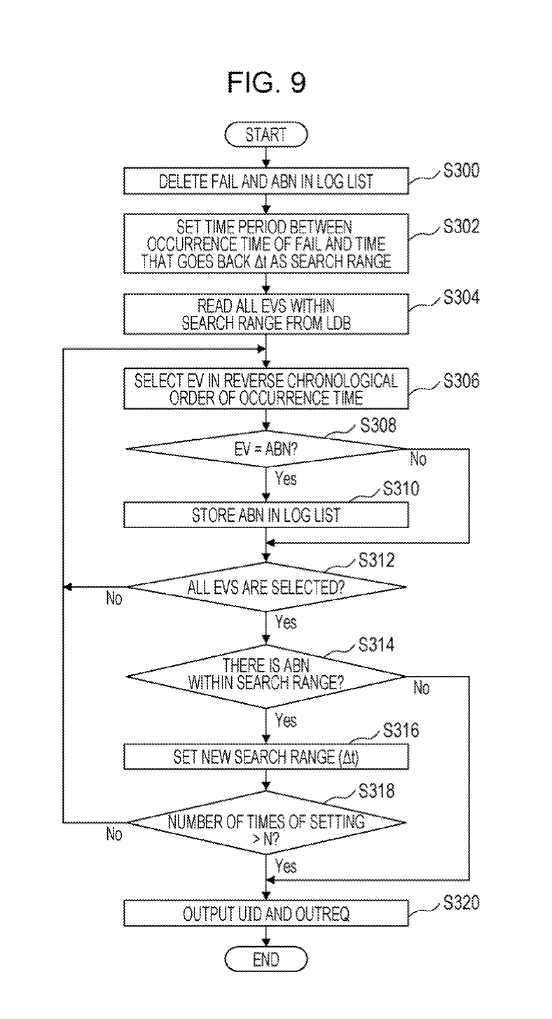

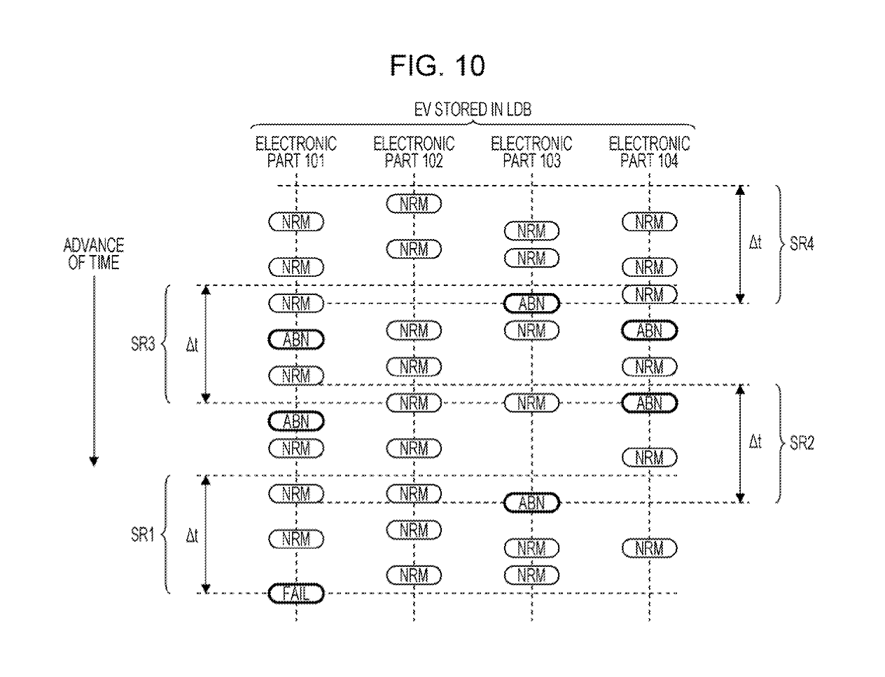

When at least one piece of abnormal information ABN is detected within the search range, the selection unit 73 sets a new search range by taking the earliest time of occurrence of the abnormal information ABN as a new reference time. When there is no abnormal information ABN within the search range, the selection unit 73 terminates the operation of selecting the abnormal information. ABN from the log database LDB. When the new search range is set, the selection unit 73 selects abnormal information included in the new search range from the log database LDB, and registers the selected abnormal information ABN in the log list 76. When no abnormal information ABN is included in the search range, the selection unit 73 terminates the operation of selecting the abnormal information ABN from the log database LDB. In this way, the selection unit 73 repeats the operation of selecting the abnormal information ABN from the log database LDB until the search for the abnormal information ABN for a predetermined period of time is completed or no more abnormal information ABN is detected within the search range. FIGS. 9 and 10 illustrate an example of the operations of the selection unit 73.

Note that the selection unit 73 may terminate the operation of selecting the abnormal information ABN from the log database LDB when the number of times of setting the extraction range reaches a predetermined number of times (for example, five times). Alternatively, the selection unit 73 may search for abnormal information ABN that has occurred within a predetermined period (for example, a period corresponding to five extraction ranges) after the time of occurrence of the failure information FAIL, without setting the search range. After terminating the operation of selecting the abnormal information ABN, the selection unit 73 outputs an output request OUTREQ to the output processing unit 74, the output request being a request to output the failure information FAIL and the abnormal information ABN registered in the log list 76 to the mounted part that has generated the failure information FAIL.

The output processing unit 74 reads the failure information FAIL and abnormal information ABN registered in the log list 76 based on the output request OUTREQ. The output processing unit 74 detects the output port P (any one of P1 to P6) coupled to the mounted part that has outputted the failure information FAIL, by referring to a route table 77 based on unique information UID for identifying the mounted parts among the information included in the read failure information FAIL. Then, the output processing unit 74 outputs, based on the detection result, a control signal CNTL for coupling the input port P0 to the output port P coupled to the mounted part that has outputted the failure information FAIL, to the switch 80. The coupling inside the switch 80 is switched based on the control signal CNTL.

After the coupling inside the switch 80 is switched, the output processing unit 74 transmits the failure information FAIL and abnormal information ABN read from the log list 76 to the mounted part that has outputted the failure information FAIL through the switch 80 and any one of the routes R21 to R26 illustrated in FIG. 3. Then, the mounted part that has generated the failure information FAIL stores the received failure information FAIL and abnormal information ABN in the non-volatile memory 500 included therein.

Note that the selection unit 73 may output the failure information FAIL selected from the log database LDB to the output processing unit 74. In this case, the output processing unit 74 may generate a control signal CNTL to switch the coupling inside the switch 80, before reading the abnormal information ABN from the log list 76, based on the unique information UID included in the failure information FAIL. Thus, the transfer of the failure information FAIL and the abnormal information ABN to the mounted part may be started earlier than the case where no failure information FAIL is received from the selection unit 73.

Moreover, as described with reference to FIG. 1, the output processing unit 74 may write the failure information FAIL and the abnormal information ABN directly into the non-volatile memory 500 in the mounted part. Furthermore, when the mounted part has a function to store the failure information FAIL generated by itself in the non-volatile memory 500, the output processing unit 74 may omit the output of the failure information FAIL to the switch 80. In this case, the selection unit 73 generates an output request OUTREQ based on the selection of the failure information FAIL from the log database LDB, but does not register the failure information FAIL in the log list 76.

The route table 77 holds information for identifying the mounted parts respectively coupled to the output ports P1 to P6 in the switch 80. More specifically, the route table 77 holds coupling information indicating coupling relationships between the output ports P1 to P6 and the mounted parts. In other words, the unique information UID for identifying each of the mounted parts is stored in the route table 77 in association with the output port (any one of P1 to P6) coupled to the mounted part. For example, the route table 77 has an information storage area for storing the unique information UID for identifying the mounted part in association with each of the output ports P1 to P6. Note that the route table 77 may be provided in an SRAM, a flash memory or the like included in the BMC 70, which are outside the output processing unit 74.

In FIG. 4, to simplify the description, reference numerals of the cards 200, the HDDs 300, and the optical drive 400 are stored as the unique information UID of the mounted parts in the information storage area of the route table 77. Note that unique information UID capable of differentiating the mounted parts from each other may be stored in the information storage area, such as information including serial numbers or information including combinations of types and serial numbers of the mounted parts.

The coupling detection unit 75 monitors voltage levels of the output ports P alternately coupled to the input port P0 in response to the control signals CNTL sequentially generated at predetermined time intervals by the output processing unit 74. The coupling detection unit 75 detects the coupling of the electronic part to the output port P based on a change in the voltage level of the output port P, and notifies the output processing unit 74 of the detection result. Note that the coupling detection unit 75 may also detect decoupling of the electronic part from the output port P, based on a change in the voltage level of the output port P, and notify the output processing unit 74 of the detection result.

When notified by the coupling detection unit 75 of the coupling of an electronic part, the output processing unit 74 stops switching of the control signals CNTL, and communicates with the electronic part newly coupled to the output port P. Then, the output processing unit 74 notifies the electronic part, through the switch 80, of the unique information UID capable of differentiating the electronic part from other electronic parts, and causes the electronic part to register the unique information UID. For example, the electronic part stores the unique information UID notified from the coupling detection unit 75 in the non-volatile memory 500. Note that, when the electronic part is previously coupled to the information processing apparatus IPE2 and has unique information UID stored therein, the output processing unit 74 receives the unique information UID previously registered in the electronic part from the electronic part. The output processing unit 74 registers the unique information UID in the information storage area corresponding to the output port P whose coupling is detected, in the route table 77. When notified by the coupling detection unit 75 of the decoupling of the electronic part, the output processing unit 74 may delete the unique information UID held in the information storage area in the route table 77 corresponding to the output port P whose coupling is released.

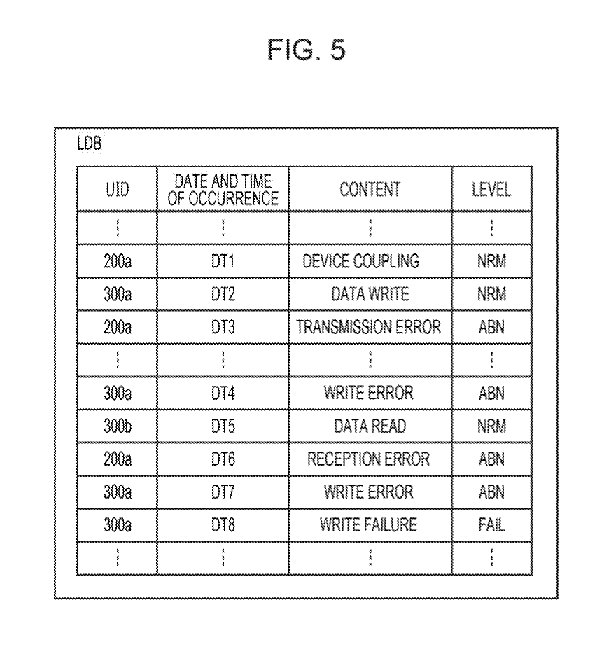

FIG. 5 illustrates an example of information stored in the log database LDB illustrated in FIG. 4. The log database LDB includes multiple entries, each including regions storing unique information UID, date and time of occurrence of event, a content of the event, and a level of the event. The unique information UID, date and time of occurrence of an event, content of the event, and level of the event stored in the log database LDB are included in event information EV to be outputted from the mounted part.

In the content of the event, “device coupling” represents that coupling of the electronic part is detected by the card 200. “Data write” represents that data is written by the HDD 300 or that data is written into an optical disk by the optical drive 400. “Transmission error” represents failure to transmit data to the HDD 300 or the optical drive 400 by the card 200. “Write error” represents occurrence of an error in the writing of data executed by the HDD 300 or the optical drive 400. “Data read” represents that data is read by the HDD 300 or that data is read from the optical disk by the optical drive 400. “Reception error” represents failure to receive data from the HDD 300 or the optical drive 400 by the card 200. “Write failure” represents continuous occurrence of a predetermined number of errors in the writing of data executed by the HDD 300 or the optical drive 400.

Since “device coupling”, “data write”, and “data read” are normal operations, the level is “NRM” (that is normal information NRM). Since “transmission error”, “reception error”, and “write error” are errors that may be retried, the level is “ABN” (that is abnormal information ABN). On the other hand, since “write failure” is an error that may not be restored by a retry, which is determined to be failure, the level is “FAIL” (that is failure information FAIL).

The selection unit 73 illustrated in FIG. 4 selects event information EV whose levels are “FAIL” and “ABN”, from among the event information EV stored in the log database LDB, as the failure information FAIL and the abnormal information ABN.

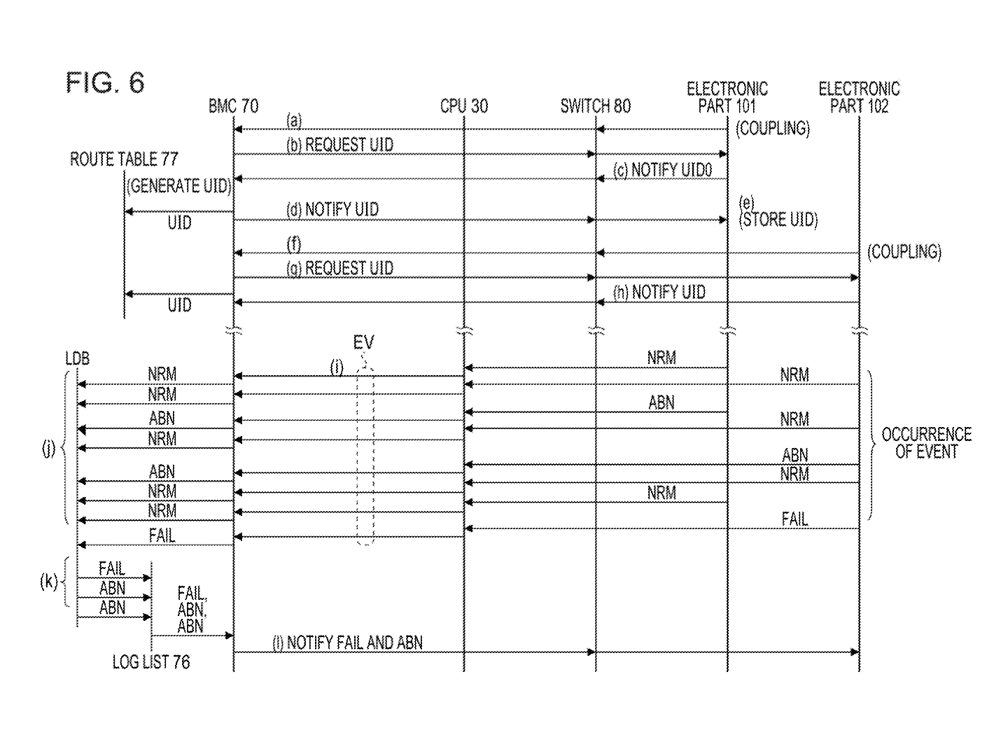

FIG. 6 illustrates an example of operations of the information processing apparatus IPE2 illustrated in FIG. 3. More specifically, FIG. 6 illustrates an example of a method for controlling the information processing apparatus IPE2, and the operations of the BMC 70 illustrated in FIG. 6 indicate an example of a program for controlling the information processing apparatus IPE2. In FIG. 6, an electronic part 101 and an electronic part 102 are the cards 200, the HDDs 300, the optical drive 400 or the like illustrated in FIG. 3. Note that, to simplify the description, FIG. 6 illustrates an example where the two electronic parts 101 and 102 are coupled to the information processing apparatus IPE2. However, the information processing apparatus IPE2 operates in the same manner as illustrated in FIG. 6 even when three or more electronic parts are coupled to the information processing apparatus IPE2.

First, the coupling detection unit 75 in the BMC 70 illustrated in FIG. 4 detects the voltage level of each of the output ports P while switching the coupling inside the switch 80, thereby detecting that the electronic part 101 is coupled to the information processing apparatus IPE2 and coupled to the switch 80 through any one of the routes R2 ((a) in FIG. 6). The output processing unit 74 in the BMC 70 requests the electronic part 101 to notify unique information UID through the switch 80 and the route R2, based on the detection by the coupling detection unit 75 ((b) in FIG. 6). More specifically, the BMC 70 makes an inquiry to the electronic part 101 about the unique information UID.

The electronic part 101 is mounted on the information processing apparatus IPE2 for the first time, and thus has no unique information UID allocated thereto. Therefore, the electronic part 101 holds no unique information UID, and notifies the output processing unit 74, through the route R2 and the switch 80, of an initial value UID0 indicating that no unique information UID is allocated to the electronic part 101 ((c) in FIG. 6).

Upon receipt of the initial value UID0, the output processing unit 74 generates new unique information UID to be allocated to the electronic part 101, and registers the generated unique information UID in the route table 77 in association with the output, port P coupled to the electronic part 101. Moreover, the output processing unit 74 notifies the electronic part 101 of the generated unique information UID through the switch 80 and the route R2 ((d) in FIG. 6). The electronic part 101 stores the unique information UID notified from the output processing unit 74 of the BMC 70, in the non-volatile memory 500 ((e) in FIG. 6). This allows the electronic part 101 to subsequently notify the CPU 30 and the BMC 70, through the input-output bus IOB, of event information EV including the unique information UID generated by the BMC 70 every time an event occurs.

Next, the coupling detection unit 75 detects that the electronic part 102 is coupled to the information processing apparatus IPE2 and the electronic part 101 is coupled to the switch 80 through the route R2 ((f) in FIG. 6). The output processing unit 74 requests the electronic part 102 to notify unique information UID through the switch 80 and the route R2 ((g) in FIG. 6).

The electronic part 102 is previously coupled to the information processing apparatus IPE2, and has previously allocated unique information UID stored in the non-volatile memory 500. In this case, the electronic part 102 reads the unique information UID from the non-volatile memory 500 and notifies the BMC 70 of the read unique information UID through the route R2 and the switch 80 ((h) in FIG. 6). The output processing unit 74 registers the unique information. UID received from the electronic part 102, in the route table 77 in association with the output port P coupled to the electronic part 102. Thereafter, the electronic part 102 outputs the event information EV including the unique information UID previously generated by the BMC 70 to the input-output bus IOB every time an event occurs.

As described above, every time the electronic part 101 or 102 is coupled to any one of the output ports P in the switch 80 through any one of the routes R2, the BMC 70 registers the unique information UID of the electronic part 101 or 102 in the route table 77 in association with the output port P. Note that, when the unique information UID is redundantly held in multiple entries in the route table 77 by the registration of the unique information UID in the route table 77, the BMC 70 deletes the unique information UID from the entry already holding the unique information. Thus, the output processing unit 74 may detect the output port P coupled to the electronic part 101 or 102 having the unique information UID allocated thereto, by referring to the route table 77.

Furthermore, the output processing unit 74 does not reallocate the unique information UID to the electronic part 102 that is previously coupled to the information processing apparatus IPE2 and has the unique information UID allocated thereto. Thus, the processing of allocating the unique information UID to the electronic part 102 may be omitted, and the processing for coupling the electronic part 102 to the information processing apparatus IPE2 may be simplified.

After the coupling of the electronic parts 101 and 102 to the information processing apparatus IPE2, the BMC 70 receives the event information EV from the electronic parts 101 and 102 through the CPU 30 ((i) in FIG. 6). The event information EV is any one of normal information NRM, abnormal information ABN, and failure information FAIL.

Upon each receipt of the event information EV, the storage processing unit 71 in the BMC 70 stores the received event information EV in the log database LDB ((j) in FIG. 6). The electronic parts 101 and 102 coupled to the information processing apparatus IPE2 output the event information EV including the allocated unique information UID to the BMC 70. Thus, the output ports P coupled to the electronic parts 101 and 102 that have generated the event information EV may be identified by referring to the event information EV stored in the log database LDB.

The monitoring unit 72 of the BMC 70 detects reception of failure information FAIL. The selection unit 73 of the BMC 70 reads the failure information FAIL and the abnormal information ABN from the log database LDB, based on the detection of the failure information FAIL by the monitoring unit 72, and stores the read failure information FAIL and abnormal information ABN in the log list 76 ((k) in FIG. 6).

The output processing unit 74 refers to the route table 77 by using the unique information UID included in the failure information FAIL, in response to the storage of the failure information FAIL and the abnormal information ABN in the log database LDB by the selection unit 73. Then, the output processing unit 74 detects the output port P coupled to the electronic part (in this example, the electronic part 102) that has generated the failure information FAIL. The output processing unit 74 controls the switch 80 to couple the input port P0 to the output port P coupled to the electronic part 102 that has generated the failure information FAIL.

Then, the output processing unit 74 outputs the failure information FAIL and abnormal information ABN stored in the log list 76 to the electronic part 102 that has generated the failure information FAIL, through the switch 80 and the route R2 ((l) in FIG. 6). Thus, the output processing unit 74 may output the failure information FAIL and the abnormal information ABN to the electronic part 102 that has generated the failure information FAIL and is coupled to any one of the output ports P, by referring to the route table 77.

Note that the output processing unit 74 may output coupling information indicating the relationship between the unique information UID and the output port P held in the route table 77, to the electronic part 102 when outputting the failure information FAIL and the abnormal information ABN to the electronic part 102. In this case, an analyst or the like who analyzes the cause of failure of the electronic part may grasp the coupling status of the electronic parts 101 and 102 to the information processing apparatus IPE2 in the event of occurrence of failure information FAIL, without making an inquiry to an operator of the information processing apparatus IPE2 or the like. As a result, the cause of failure may be more readily specified compared with the case where no coupling information is outputted to the electronic part 102.

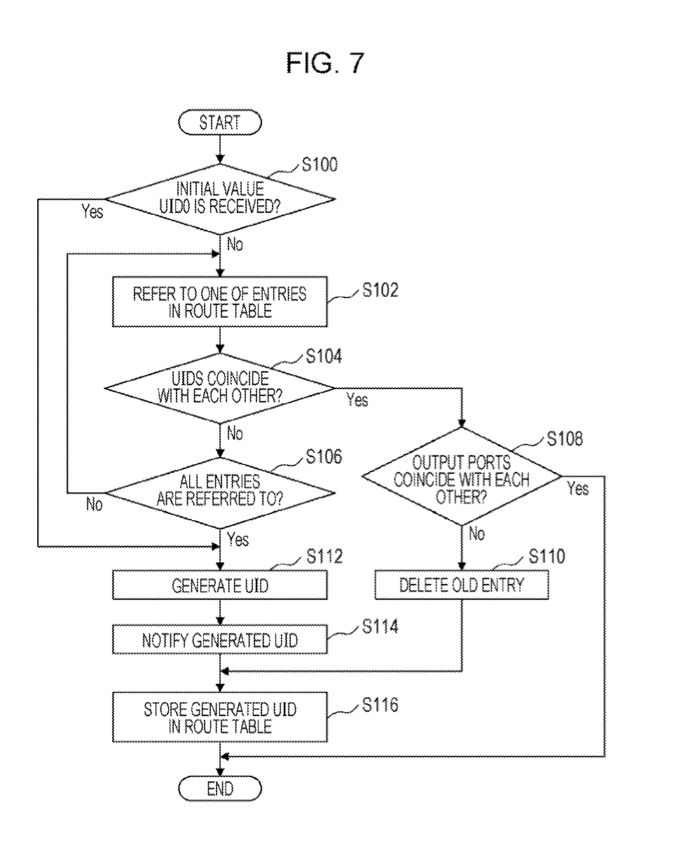

FIG. 7 illustrates an example of an operational flowchart for operations when the coupling of the electronic parts to the output ports P is detected by the BMC illustrated in FIG. 4. More specifically, FIG. 7 illustrates an example of a method for controlling the information processing apparatus IPE2 and the program for controlling the information processing apparatus IPE2. The processing illustrated in FIG. 7 is the processing from requesting the electronic parts 101 and 102 to notify the unique information UID to registering the unique information UID in the route table 77 in FIG, 6, and is executed by the output processing unit 74 illustrated in FIG. 4.

First, in Step S100, the output processing unit 74 determines whether or not an initial value UID0 of unique information is received from an electronic part coupled to the information processing apparatus IPE2. When the initial value UID0 is received, the output processing unit 74 determines that the electronic part is coupled to the information processing apparatus IPE2 for the first time, and advances the processing to Step S112. When no initial value UID0 is received, that is, when unique information UID other than the initial value UID0 is received, the output processing unit 74 determines that the electronic part previously coupled to the information processing apparatus IPE2 is coupled to the information processing apparatus IPE2, and advances the processing to Step S102.

In Step S102, the output processing unit 74 refers to one of the entries in the route table 77. Next, in Step S104, the output processing unit 74 determines whether or not the unique information UID received from the electronic part coincides with the unique information UID included in the entry referred to. When the both pieces of unique information UID coincide with each other, the output processing unit 74 determines that the electronic part is temporarily removed from the information processing apparatus IPE2 and then recoupled to the information processing apparatus IPE2, and advances the processing to Step S108. When the both pieces of unique information UID do not coincide with each other, the output processing unit 74 advances the processing to Step 5106 to refer to the next entry.

In Step S106, the output processing unit 74 determines whether or not all the entries in the route table 77 are referred to. When all the entries are referred to, the output processing unit 74 determines that the electronic part previously coupled to the information processing apparatus IPE2 or an electronic part coupled to another information processing apparatus is coupled to the information processing apparatus IPE2, and advances the processing to Step S112. When there are entries yet to be referred to, the output processing unit 74 returns the processing to Step S102 to refer to a next entry. Note that, when continuing to use the unique information UID once registered with the electronic part, the output processing unit 74 may advance the processing to Step S116, rather than Step S112, after determining in Step S106 that all the entries are referred to.

In Step S108, the output processing unit 74 determines whether or not an output port P detected to be coupled to the electronic part corresponds to an output port P of the entry with the corresponding unique information UID. When the output ports P correspond to each other, the output processing unit 74 determines that the electronic part is temporarily removed from the output port P and then recoupled to the same output port P, and then terminates the processing without updating the route table 77. When the output ports P do not correspond to each other, the output processing unit 74 determines that the corresponding entry in the route table 77 is an old entry that does not indicate the actual coupling status, and advances the processing to Step S110.

In Step S110, the output processing unit 74 deletes the unique information UID held in the old entry in the route table 77, and advances the processing to Step S116.

Meanwhile, in Step S112, the output processing unit 74 generates unique information UID to be allocated to the electronic part coupled to the information processing apparatus IPE2. Next, in Step S114, the output processing unit 74 notifies the electronic part of the generated unique information UID through the switch 80 and the route R2. Then, in Step S116, the output processing unit 74 stores the generated unique information UID in the entry of the route table 77, corresponding to the route R2 coupled to the electronic part, and then terminates the processing.

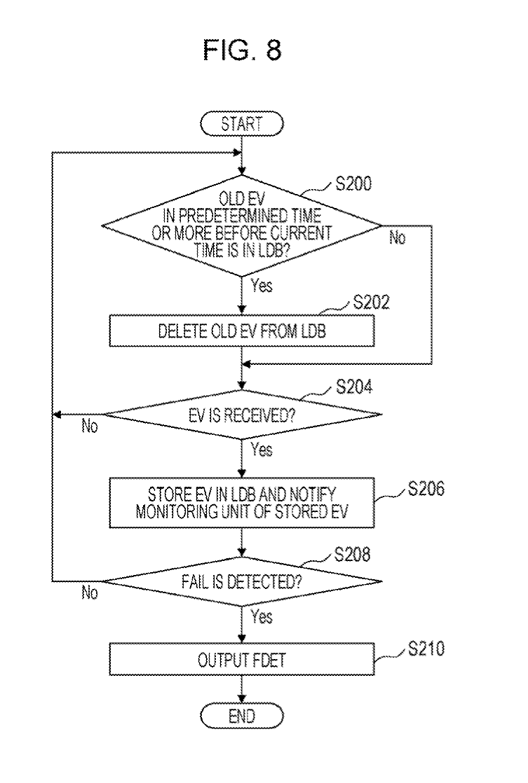

FIG. 8 illustrates an example of an operation of storing the event information EV in the log database LDB by the BMC 70 illustrated in FIG. 4. More specifically, FIG. 8 illustrates an example of a method for controlling the information processing apparatus IPE2 and the program for controlling the information processing apparatus IPE2. The processing illustrated in FIG. 8 is executed by the storage processing unit 71 and the monitoring unit 72 illustrated in FIG. 4.

First, in Step S200, the storage processing unit 71 determines whether or not old event information EV, which has occurred at a time point earlier than the current time by a predetermined time or more, is held in the log database LDB. The storage processing unit 71 advances the processing to Step S202 when the log database LDB holds the old event information EV, and advances the processing to Step S204 when the log database LDB holds no old event information EV. In Step S202, the storage processing unit 71 deletes the old event information EV detected in Step S200. Thereafter, the storage processing unit 71 advances the processing to Step S204.

When receiving the event information EV from the CPU 30 in Step S204, the storage processing unit 71 advances the processing to Step S206. When receiving no event information EV from the CPU 30, the storage processing unit 71 returns the processing to Step S200. In Step S206, the storage processing unit 71 stores the received event information EV in the log database LDB, and notifies the monitoring unit 72 of the event information EV stored in the log database LDB.

Next, in Step S208, the monitoring unit 72 determines, based on the event information EV notified from the storage processing unit 71, whether or not the event information EV stored in the log database LDB is failure information FAIL. When the event information EV is the failure information FAIL, the monitoring unit 72 advances the processing to Step S210. When the event information EV is not the failure information FAIL (that is, when the event information EV is normal information NRM or abnormal information ABN), the monitoring unit 72 returns the processing to Step S200. In Step S210, the monitoring unit 72 outputs detection information FDET indicating detection of the occurrence of the failure information FAIL to the selection unit 73, and then terminates the processing.

FIG. 9 illustrates an example of an operation of storing failure information FAIL and abnormal information ABN selected from the log database LDB in the log list 76 by the BMC 70 illustrated in FIG. 4. More specifically, FIG. 9 illustrates an example of a method for controlling the information processing apparatus IPE2 and the program for controlling the information processing apparatus IPE2. The processing illustrated in FIG. 9 is executed by the selection unit 73 (FIG. 4) that has received the detection information FDET from the monitoring unit 72.

First, in Step S300, the selection unit 73 deletes the failure information FAIL and abnormal information ABN held in the log list 76. Next, in Step S302, the selection unit 73 sets a time period from a time of occurrence (starting point) of the failure information FAIL to a time (end point) that goes back a first period At as a search range for searching for the abnormal information ABN. Next, in Step S304, the selection unit 73 reads all the event information EV whose times of occurrence are within the search range, among the event information EV held in the log database LDB, from the log database LDB.

Next, in Step S306, the selection unit 73 selects the event information EV read from the log database LDB in reverse chronological order of the time of occurrence. Then, in Step S308, the selection unit 73 advances the processing to Step S310 when the selected event information EV is the abnormal information ABN, and advances the processing to Step S312 when the selected event information EV is not the abnormal information ABN (that is, when the selected event information EV is the normal information NRM). The selection unit 73 stores the selected abnormal information ABN in the log list 76 in Step S310, and then advances the processing to Step S312.

When all the event information EV within the search range is selected in Step S312, the selection unit 73 advances the processing to Step S314. When there is event information EV yet to be selected within the search range, the selection unit 73 returns the processing to Step S306. In Step S314, the selection unit 73 determines whether or not there is abnormal information ABN in the event information EV within the search range read from the log database LDB. When there is abnormal information ABN within the search range, the selection unit 73 advances the processing to Step S316, When there is no abnormal information ABN within the search range, the selection unit 73 advances the processing to Step S320.

Thereafter, in Step S316, the selection unit 73 detects the abnormal information ABN with the earliest time of occurrence, among the abnormal information ABN within the search range read from the log database LDB. The selection unit 73 sets a time period from a new starting point that is the time of occurrence of the detected abnormal information ABN to a time (end point) that goes back a first period Δt from the starting point as a new search range for searching for the abnormal information ABN.

Next, when the number of times of setting the search range exceeds a predetermined number of times N (for example, five times) in Step S318, the selection unit 73 advances the processing to Step S320. When the number of times of setting the search range is not more than the predetermined number of times N, the selection unit 73 returns the processing to Step S306 to execute the processing of detecting abnormal information ABN within the new search range set in Step S316.

Then, in Step S320, the selection unit 73 outputs an output request OUTREQ, together with the unique information UID indicating the mounted part that has generated the failure information FAIL, to the output processing unit 74, and then terminates the processing.

FIG. 10 illustrates an example of processing of extracting the failure information FAIL and the abnormal information ABN from the log database LDB by the processing illustrated in FIG. 9. In the example illustrated in FIG. 10, four electronic parts 101, 102, 103, and 104 are coupled to the information processing apparatus IPE2. To simplify the description, the event information EV (normal information NRM, abnormal information ABN, and failure information FAIL) held in the log database LDB is illustrated in chronological order for each electronic part.

First, the selection unit 73 sets a time period from a time of occurrence of the failure information FAIL to a time that goes back a first period Δt as a search range SRI, and extracts abnormal information ABN within the search range SR1.

Since there is abnormal information ABN in the search range SR1, the selection unit 73 detects the abnormal information ABN with the earliest time of occurrence, among the abnormal information ABN within the search range SR1 read from the log database LDB. The selection unit 73 sets a time period from a new starting point that is the time of occurrence of the detected abnormal information ABN to a time that goes back the first period At from the starting point as a new search range SR2, and extracts abnormal information ABN within the search range SR2.

Since there is abnormal information ABN in the search range SR2 the selection unit 73 detects the abnormal information ABN with the earliest time of occurrence, among the abnormal information ABN within the search range SR2 read from the log database LDB. The selection unit 73 sets a time period from a new starting point that is the time of occurrence of the detected abnormal information ABN to a time that goes back the first period Δt from the starting point as a new search range SR3, and extracts abnormal information ABN within the search range SR3.

Since there is abnormal information ABN in the search range SR3, the selection unit 73 detects the abnormal information ABN with the earliest time of occurrence, among the abnormal information ABN within the search range SR3 read from the log database LDB. The selection unit 73 sets a time period from a new starting point that is the time of occurrence of the detected abnormal information ABN to a time that goes back the first period Δt from the starting point as a new search range SR4, and extracts abnormal information ABN within the search range SR4.

In the example illustrated in FIG. 10, since there is no abnormal information ABN in the search range SR4, the extraction of the abnormal information ABN from the log database LDB is completed. Note that, when the predetermined number of times N is three times in Step S318 illustrated in FIG. 9, the selection unit 73 extracts the abnormal information ABN within the search range SR3 and then terminates the extraction of the abnormal information ABN from the log database LDB.

In FIG. 10, determination of whether to further extract the abnormal information ABN is made based on whether or not abnormal information ABN has occurred in the first period Δt that is determined by taking the time of occurrence of the failure information FAIL or the time of occurrence of the abnormal information ABN as the starting point for going back. Accordingly, the time period for extracting the abnormal information ABN changes with the frequency of occurrence of the abnormal information ABN. Therefore, compared with the case of extracting abnormal information ABN that has occurred in a fixed period that is predetermined based on the time of occurrence of the failure information FAIL, the possibility of extracting the abnormal information ABN related to a failure of the mounted part may be increased.

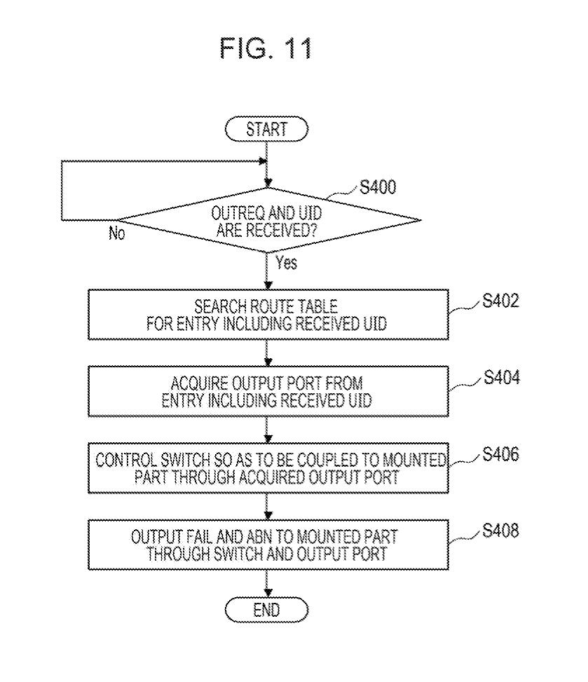

FIG. 11 illustrates an example of an operation of outputting the failure information FAIL and abnormal information ABN stored in the log list 76 to the mounted part that has generated the failure information FAIL, through the switch 80 and the route R2, by the BMC 70 illustrated in FIG. 4. More specifically, FIG. 11 illustrates an example of a method for controlling the information processing apparatus IPE2 and the program for controlling the information processing apparatus IPE2. The processing illustrated in FIG. 11 is executed by the output processing unit 74 illustrated in FIG. 4.

First, in Step S400, the output processing unit 74 waits to receive an output request OUTREQ and unique information UID to be outputted from the selection unit 73. Upon receipt of the output request OUTREQ and the unique information UID, the output processing unit 74 advances the processing to Step S402. In Step S402, the output processing unit 74 searches the route table 77 for an entry including the unique information UID received from the selection unit 73.

Next, in Step S404, the output processing unit 74 acquires an output port P from the entry including the unique information UID. Then, in Step S406, the output processing unit 74 outputs a control signal CNTL to the switch 80, and couples the input port P0 of the switch 80 to the output port P acquired in Step S404. Thus, the input, port P0 of the switch 80 is coupled to the mounted part that has generated the failure information, through the output port P and the route R2.

Thereafter, in Step S408, the output processing unit 74 outputs the failure information FAIL and abnormal information ABN stored in the log list 76 to the mounted part that has generated the failure information FAIL, through the switch 80 and the route R2, and then terminates the processing. The mounted part that has generated the failure information FAIL stores the received failure information FAIL and abnormal information ABN in the non-volatile memory 500. More specifically, the output processing unit 74 causes the failure information FAIL and the abnormal information ABN to be stored in the non-volatile memory 500 of the mounted part that has generated the failure information FAIL.

As described above, in the embodiment illustrated in FIGS. 3 to 11, the same effects may be achieved as those achieved in the embodiment illustrated in FIGS. 1 and 2. More specifically, the BMC 70 transfers the failure information and the abnormal information ABN to the routes R21 to R26, which are different from the input-output bus IOB used in a normal operation. Therefore, the failure information FAIL and abnormal information ABN generated by the mounted part may be stored, together with the abnormal information ABN generated by another mounted part, in the electronic part that has generated the failure information FAIL without being affected by the influence of failure. As a result, for example, the possibility that the cause of failure will be specified may be increased in the case of analyzing the cause of occurrence of the failure information. FAIL, by using the mounted part that has generated the failure information FAIL, at a location different from a location where the information processing apparatus IPE2 is installed.

Furthermore, the following effects may be achieved in the embodiment illustrated in FIGS. 3 to 11. Repeated setting of the first period Δt and extraction of the abnormal information ABN held in the log database LDB may increase the possibility of extracting the abnormal information ABN related to a failure of the mounted part, compared with the case of extracting the abnormal information ABN that has occurred in the fixed period.

The BMC 70 registers the unique information UID of the electronic part in the route table 77 in association with the output port P every time the electronic part is coupled to the information processing apparatus IPE2. Therefore, the output port P coupled to the electronic part may be detected by referring to the route table 77. In other words, as illustrated in FIG. 6, the output processing unit 74 may output the failure information FAIL and the abnormal information ABN to the electronic part 102 that has generated the failure information FAIL and is coupled to any one of the output ports P, by referring to the route table 77, The unique information UID is not reallocated to the electronic part to which the unique information UID has already been allocated. Thus, the processing for coupling the electronic part to the information processing apparatus IPE2 may be simplified.

The features and advantages of the embodiments will become apparent from the above detailed description. The scope of claims is intended to cover the features and advantages of the embodiments as described above without departing from the spirit and scope of right thereof. Moreover, those having conventional knowledge in the field may easily conceive various modifications and changes. Therefore, the scope of the embodiments having the inventiveness is not intended to be limited to that described above, but may include modifications and equivalents which fall within the scope disclosed by the embodiments.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An apparatus comprising:
a plurality of mounting slots each configured to mount an electronic part including a first memory;
a second memory; and
a processor coupled to the second memory and configured to:
collect, through a first path, from the electronic part mounted on each of the plurality of mounting slots, event information indicating an operating state of the electronic part,
store the collected event information in the second memory, and
when the event information stored in the second memory has a first level of importance, cause the event information stored in the second memory to be stored, through a second route, in the first memory of the electronic part from which the event information of the first level of importance has been collected.

2. The apparatus of claim 1, further comprising:
a switch circuit including a plurality of first ports and a second port, each of the plurality of first ports being coupled to the electronic part mounted on different one of the plurality of mounting slots through the second route, the switch circuit being configured to couple any one of the plurality of first ports to the second port, wherein
when the event information stored in the second memory is of the first level of importance, the processor outputs, to the switch circuit, control information for coupling one of the plurality of first ports which is coupled to the electronic part that has outputted the event information of the first level of importance, to the second port, based on coupling information indicating coupling relationships between the plurality of first ports and electronic parts mounted on the plurality of mounting slots.

3. The apparatus of claim 2, wherein
the event information collected from the electronic part through the first route includes unique information for identifying the electronic part; and
the processor is configured to:
upon detecting a state in which a first electronic part has been coupled to one of the plurality of first ports, update the coupling information by storing the unique information for identifying the first electronic part in the coupling information in association with the one of the plurality of first ports which is coupled to the first electronic part,
when the event information of the first level of importance is stored in the second memory, control the switch circuit according to the updated coupling information, and
output the event information of a second level of importance indicating importance lower than the first level of importance, to the electronic part that has outputted the event information of the first level of importance.

4. The apparatus of claim 3, wherein
the processor is configured to output the coupling information, together with the event information of the second level of importance, to the electronic part that has outputted the event information of the first level of importance.

5. The apparatus of claim 3, wherein
the processor is configured to:
make an inquiry to the first electronic part about the unique information, and
update the coupling information by storing the unique information outputted from the electronic part in the coupling information, in association with one of the plurality of first ports which is coupled to the first electronic part.

6. The apparatus of claim 5, wherein
when it is detected, based on the inquiry about the unique information, that the first electronic part holds no unique information, the processor outputs the unique information to be held by the first electronic part to the first electronic part through the second route, and updates the coupling information by storing the unique information outputted to the first electronic part in the coupling information, in association with the one of the plurality of first ports which is coupled to the first electronic part.

7. The apparatus of claim 3, wherein
the processor is further configured to:
monitor the event information that is stored in the second memory;
upon detecting that the event information of the first level of importance has been stored in the second memory, select the event information of the second level of importance which has occurred in a previous period before a starting point that is a time of occurrence of the event information of the first level of importance, from among the event information stored in the second memory;
repeat a process of selecting the event information of the second level of importance which has occurred, in a next previous period before a starting point that is an earliest time of occurrence of the event information of the second level of importance within the previous period, until there is no occurrence of the event information of the second level of importance within the next previous period; and
output the selected event information of the second level of importance to the second port.

8. The apparatus of claim 3, wherein
the processor is configured to cause the event information of the first level of importance which is stored in the second memory, to be stored, together with the event information of the second level, in the first memory of the electronic part that has outputted the event information of the first level of importance, through the second route.

9. The apparatus of claim 1, wherein
each of the plurality of first ports is coupled to another electronic part that is coupled to a connector mounted on the electronic part which is mounted on one of the plurality of mounting slots.

10. The apparatus of claim 1, wherein
the event information of the first level of importance is failure information indicating a failure detected by the electronic part; and
the processor stores, among the event information stored in the second memory, the event information of the second level of importance indicating an abnormal operation detected by the electronic part, in the first memory of the electronic part that has outputted the event information of the first level of importance, through the second route.

11. The apparatus of claim 10, wherein
the event information of the second level of importance is information indicating an abnormal operation detected by the electronic part, which is related to the failure information.

12. A method for controlling an information processing apparatus including a plurality of mounting slots each configured to mount an electronic part including a first memory, the method comprising:
collecting, through a first path, from the electronic part mounted on each of the plurality of mounting slots, event information indicating an operating state of the electronic part;
storing the collected event information in a second memory; and
when the event information stored in the second memory has a first level of importance, causing the event information stored in the second memory to be stored, through a second route, in the first memory of the electronic part from which the event information having the first level of importance has been collected.

13. A non-transitory, computer-readable recording medium having stored therein a program for causing a computer included in an information processing apparatus to execute a process, the information processing apparatus including a plurality of mounting slots each configured to mount an electronic part including a first memory, the process comprising:
collecting, through a first path, from the electronic part mounted on each of the plurality of mounting slots, event information indicating an operating state of the electronic part;
storing the collected event information in a second memory provided for the computer; and
when the event information stored in the second memory has a first level of importance, causing the event information stored in the second memory to be stored, through a second route, in the first memory of the electronic part from which the event information having the first level of importance has been collected.
